(19) United States
(12) Patent Application Publication
(10) Pub. No.: US 2018/0250951 A1
(43) Pub. Date: Sep. 6, 2018

(54) PRINTER

(71) Applicant: FUJITSU COMPONENT LIMITED, Tokyo (JP)

(72) Inventors: Yoichi Takamura, Tokyo (JP); Noriyuki Ishida, Tokyo (JP)

(21) Appl. No.: 15/903,177

(22) Filed: Feb. 23, 2018

(30) Foreign Application Priority Data
Mar. 3, 2017 (JP) 2017-040742

(51) Int. Cl. B41J 2/35; B41J 23/00

(52) U.S. Cl. CPC B41J 2/35; B41J 23/00

(57) ABSTRACT

A printer includes: a printing head including a plurality of resistors; a controller configured to drive the printing head by dividing the printing head into at least two areas; and an assisting circuit that assists power supply, wherein the controller controls to overlap time periods for driving two different areas, and the assisting circuit supplies an electric current to the printing head together with an electric current supplied from the power source during the overlapping period.

### BACKGROUND

### 1. Field of the Invention

The disclosures herein relate to a printer.

### 2. Description of the Related Art

Printers are widely used in cash registers, ATMs (automatic teller machines) or CDs (cash dispensers), etc. As such printers, a thermal printer performs printing on a recording sheet by a thermal head. A mobile type small printer that is driven by a battery is present.

In a thermal printer, if an electric current flows at the time of printing is large, a voltage drop of a battery becomes large and may cause an inconvenience.

Therefore, a thermal printer that is able to perform printing with suppressing a voltage drop of a battery is required.

### RELATED-ART DOCUMENTS

### Patent Document

[Patent Document 1] Japanese Unexamined Patent Application Publication No. 2009-148948

[Patent Document 2] Japanese Unexamined Patent Application Publication No. 2010-131815

[Patent Document 3] Japanese Unexamined Patent Application Publication No. S61-248759

### SUMMARY OF THE INVENTION

According to one aspect of the embodiments, a printer includes: a printing head including a plurality of resistors; a controller configured to drive the printing head by dividing the printing head into at least two groups; and an assisting circuit that assists power supply, wherein the controller controls to overlap time periods for driving two different areas, and the assisting circuit supplies an electric current to the printing head together with an electric current supplied from the power source during the overlapping period.

### BRIEF DESCRIPTION OF THE DRAWINGS

FIG. 1A and FIG. 1B are diagrams of a division of print dots of a thermal head.

FIG. 2A is a diagram of an electric current when print dots are not divided.

FIG. 2B is a diagram of an electric current when a printing head is divided into two groups.

FIG. 2C is a diagram of an electric current when a printing head is divided into four groups.

FIG. 3 is a diagram of a printer according to a first embodiment.

FIGS. 4A and 4B are diagrams of an assisting circuit according to the first embodiment.

FIG. 5 is a diagram of an electric current that flows in the thermal head according to the first embodiment.

FIG. 6 is a diagram of a variation of the assisting circuit.

FIGS. 7A and 7B are diagrams of a variation of the assisting circuit.

FIGS. 8A and 8B are diagrams of a variation of the assisting circuit.

FIG. 9 is a block diagram of a printer that is driven by a battery.

FIG. 10 is a block diagram of a driver.

FIG. 11 is a block diagram of a printer according to a second embodiment.

FIG. 12 is a block diagram of a driver according to the second embodiment.

FIG. 13 is a flowchart illustrating a control method of the printer according to the second embodiment.

FIG. 14 is a flowchart illustrating a control method of a printer according to a third embodiment.

FIG. 15 is a flowchart illustrating a control method of a printer according to a fourth embodiment.

### DESCRIPTION OF THE EMBODIMENTS

In the following, embodiments for implementing the present invention will be described. The same members or the like are referred to by the same numerals, and their descriptions will be omitted as appropriate. Various kinds of calculation are performed every time printing control is performed in the following description, but a process may be performed by using a table.

### First Embodiment

When printing on a thermal paper is performed, an electric current flows to resistors of a thermal head to heat the resistors. The electric current that flows in the thermal head may change depending on the number of dots energized simultaneously, and a voltage drop of a power source may occur when a large electric current flows at once.

There is a method for driving a thermal head by dividing print dots to reduce an electric current that flows in the thermal head at the time of printing. In this method, an electric current flows for each divided group of the print dots, and the electric current that flows at once can be reduced. However, because the thermal head need to be energized for plural times per line, the printing time becomes longer and the printing speed decreases.

There is a method for connecting electrolytic capacitors in parallel to a power source to suppress a voltage drop when a large electric current instantaneously flows in a thermal head. By connecting the electrolytic capacitors in parallel to the power source, electric charge stored in the electrolytic capacitors is supplied to the thermal head when energizing the thermal head and a power source load can be reduced. However, in some types of a thermal head, an electric current of 24 V and 10 A may flow at maximum. Thus, an electrolytic capacitor having large capacity is required to reduce the power source load and this leads to increase the size and cost of a printer.

A printer according to the present embodiment is a thermal printer that suppresses a decrease of a printing speed even if print dots of a thermal head are divided when printing a single line, and that does not increase a power source load even when a capacitor having a relatively small capacity is used.

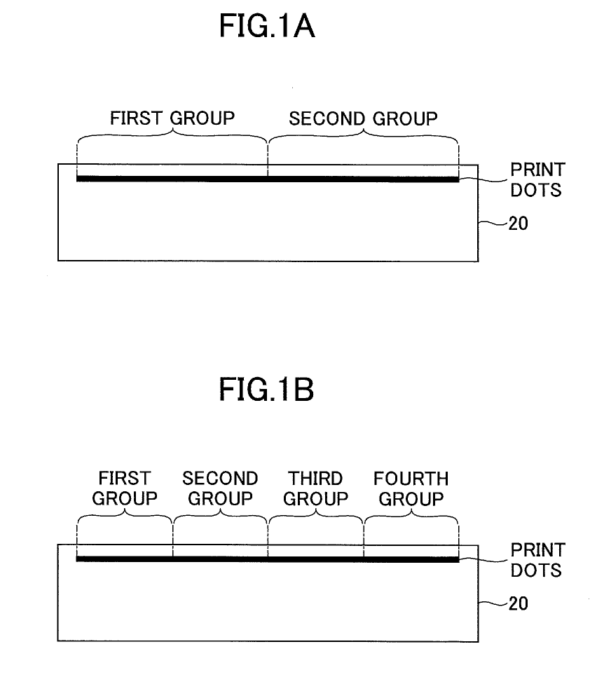

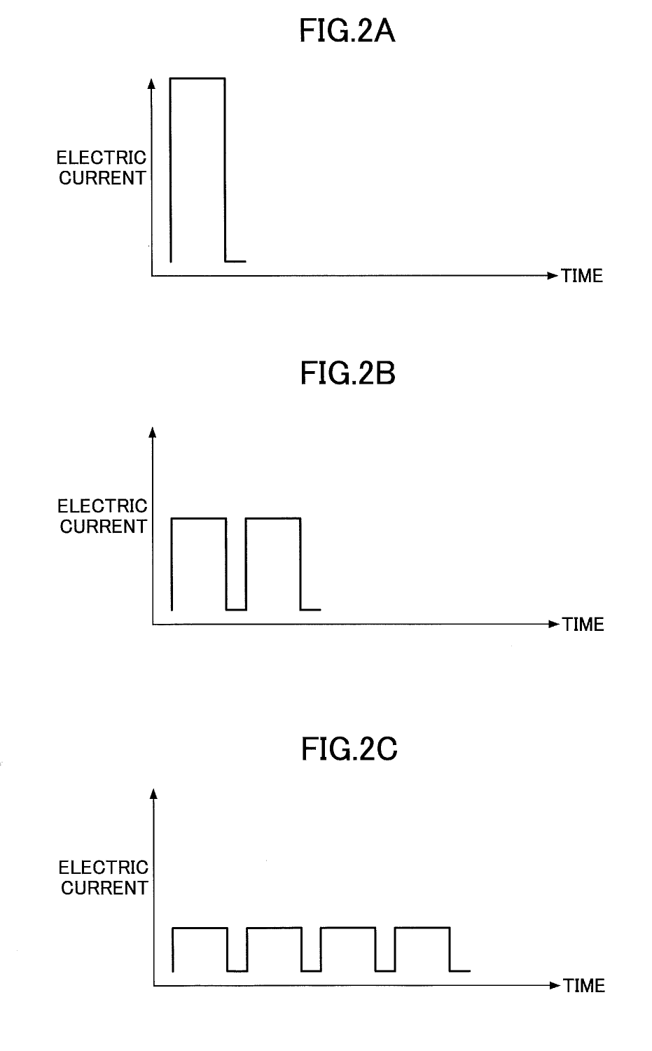

Divisional driving of print dots of a thermal head 20 (“dot-divisional mode”) will be described with reference to FIGS. 1A and 1B and FIGS. 2A to 2C. When the print dots to be driven are divided into plural groups, the print dots may be divided in any suitable manner. As illustrated in FIG. 1A, the print dots may be divided into two groups, a first group and a second group. Alternatively, as illustrated in FIG. 1B, the print dots may be divided into four groups, a first group, a second group, a third group, and a fourth group. By dividing the print dots into plural groups and drive each group one by one to print a single line, an electric current supplied from a power source at the time of driving the print dots can be suppressed.

FIG. 2A illustrates an electric current when print dots are not divided. FIG. 2B illustrates an electric current when a printing head is divided into two groups. FIG. 2C illustrates an electric current when a printing head is divided into four groups.

As illustrated in FIG. 2A, when an electric current flows in all print dots at a time, the printing can be performed by a short time period but a large electric current flows at once. In contrast, as illustrated in FIG. 2B, when the printing head is divided into two groups, the electric current that flows at once can be reduced to substantially half comparing to FIG. 2A, but the printing time becomes twice or more. Also, as illustrated in FIG. 2C, when the printing head is divided into four groups, the electric current that flows at once can be reduced to substantially quarter comparing to FIG. 2A, but the printing time period becomes quadruple or more.

In FIGS. 2B and 2C, a time period in which an electric current does not flow to the thermal head is set, and the printing time period becomes much longer by this time period in dot-divisional mode.

### <Printer>

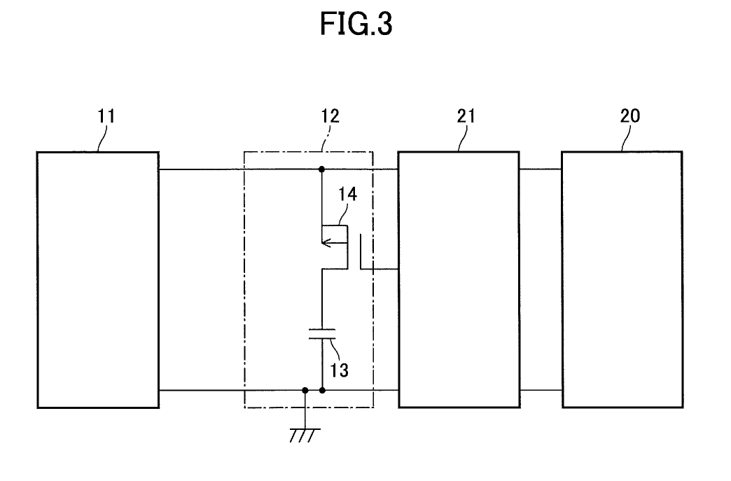

A printer according to the first embodiment will be described with reference to FIG. 3. As illustrated in FIG. 3, an assisting circuit 12 is provided between a power source 11 and a head controller 21 that controls driving of a thermal head 20. The assisting circuit 12 illustrated in FIG. 3 includes a capacitor 13 and a field effect transistor (FET) 14 connected in series. The capacitor 13 is connected to the negative side of the power source 11, and the FET 14 is connected to the positive side of the power source 11. For example, the FET 14 may be a Pch-FET.

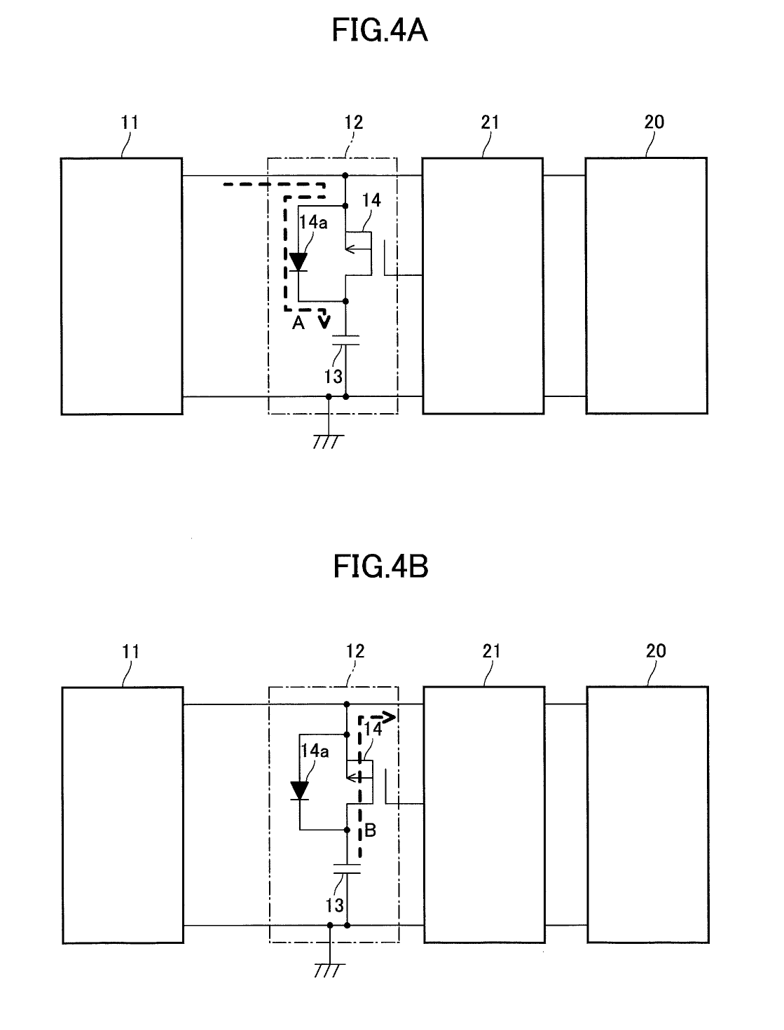

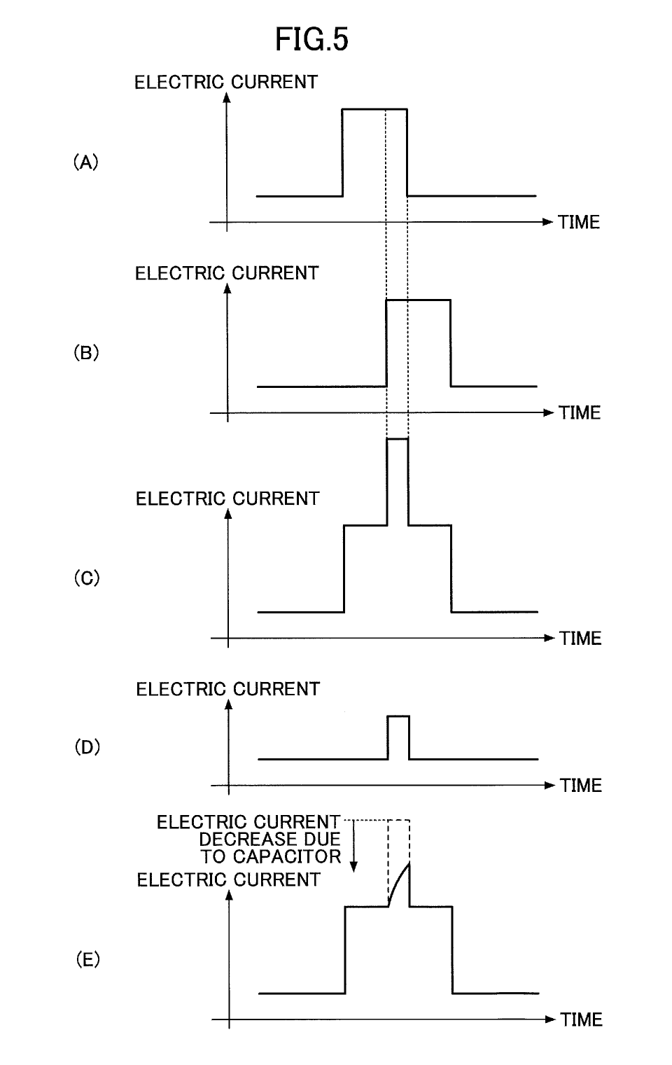

A parasitic diode 14a is formed on the FET 14. As illustrated in FIG. 4A, when the FET 14 is in an off state, an electric current flows from the power source 11 to the capacitor 13 via the parasitic diode 14a of the FET 14 as illustrated by the dashed arrow A, and the capacitor 13 is charged. As illustrated in FIG. 4B, when the FET 14 is in an on state, the electric charge stored in the capacitor 13 flows as illustrated by the dashed arrow B and is supplied to the head controller 21 via the FET 14 together with the electric current supplied from the power source 11. The capacitor 13 can be considered as an auxiliary power source, because the capacitor 13 supplies the electric charge to the head controller 21.

(A) to (E) of FIG. 5 each illustrate an electric current that flows in the thermal head 20 when driving the thermal head 20. In (A) to (E) of FIG. 5, the horizontal axis represents time and the vertical axis represents an electric current.

(A) of FIG. 5 illustrates an electric current that flows when a first group of divided print dots is driven, and (B) of FIG. 5 illustrates an electric current that flows when a second group of print dots is driven. According to the present embodiment, when the thermal head 20 is driven by dividing print dots into two groups, a time period in which the first group is driven and a time period in which the second group is driven partially overlap. (C) of FIG. 5 illustrates an electric current that flows in the thermal head 20 when the driving time periods partially overlap. Because the time periods of driving the first group and the second group overlap, the print time required for printing using the first group and the second group can be made shorter than the twice of the print time for driving all print dots in one lump, and a decrease of the printing speed can be suppressed.

As illustrated in (C) of FIG. 5, during the time period in which the time period for driving the first group and the time period for diving the second group overlap (“overlapping period”), an electric current in which the electric current applied to the first group as illustrated in (A) of FIG. 5 and the electric current applied to the second group as illustrated in (B) of FIG. 5 are added flows, and is substantially the same as an electric current that flows in the thermal head when print dots are not divided.

According to the present embodiment, a part of the electric current flows in the thermal head 20 is supplied by electric charge stored in the capacitor 13. (D) of FIG. 5 illustrates the electric current that is supplied from the capacitor 13. (E) of FIG. 5 illustrates an electric current that is applied from the power source 11 when the electric current flows from the capacitor 13, and a dashed area corresponds to an electric current that flows in the overlapping period illustrated in (C) of FIG. 5.

The FET 14 is turned on during the overlapping period, and electric charge stored in the capacitor 13 is supplied to increase the electric current flows in the thermal head 20. On the other hand, the FET 14 is turned off during a period other than the overlapping period.

Accordingly, even when an electric current flows in the thermal head 20 increases during the overlapping period, the load of the power source 11 does not increase so much because a part of the electric current can be supplied from the capacitor 13. However, as illustrated in (E) of FIG. 5, the amount of electric current supplied from the capacitor 13 decreases with time due to discharging of the capacitor 13. In order to make up for the decrease, the electric current supplied from the power source 11 gradually increases.

Upon shortening the overlapping period, the peak of an electric current supplied from the power source 11 can be suppressed and a voltage drop of the power source 11 can be suppressed. Also, when the overlapping period is shortened, an effect caused by a decrease of the amount of electric current from the capacitor 13 can be suppressed even if the capacity of the capacitor 13 is not so large and the peak electric current can be suppressed.

According to the present embodiment, the load only applies to the capacitor 13 when the FET 14 is turned on, and when the FET 14 is turned off for charging the capacitor 13. Thus, the load on the capacitor 13 can be reduced relative to a case in which control using the FET 14 is not performed, and the size of the capacitor 13 can be reduced and the printer can be prevented from growing in size. Further, even when the thermal head 20 is driven in a dot-divisional mode, a peak electric current from the power source 11 can be suppressed and a printing time period can be shortened. Note that on and off of the FET 14 is controlled by the head controller 21, and the capacitor 13 is charged when printing is not performed by the thermal head 20.

According to a printer of the present embodiment, it is possible to reduce a print time period and to perform printing without increasing the load on a power source even when print dots are driven in a dot-divisional mode.

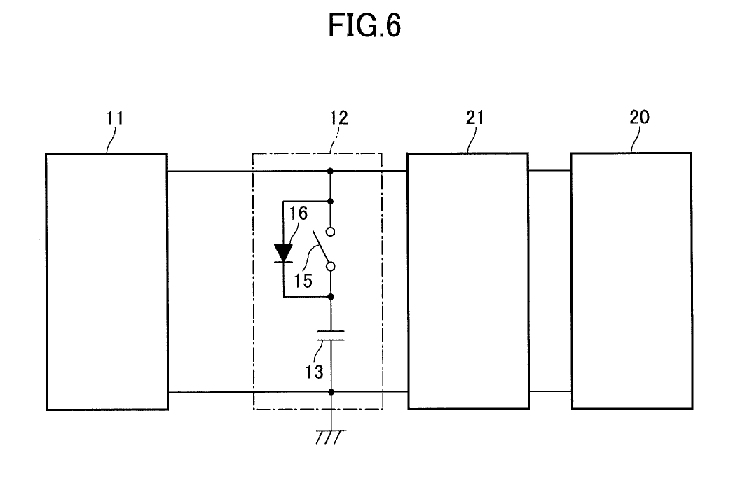

Although the assisting circuit 12 includes FET 14 in the embodiment described above, the assisting circuit 12 may include another switch instead of the FET 14. As illustrated in FIG. 6, the capacitor 13 and a switch 15 may be connected in series, and the capacitor 13 is connected to the negative terminal and the switch 15 is connected to the positive terminal of the power source. Further, in the example illustrated in FIG. 6, a diode 16 is connected in parallel to the switch 15.

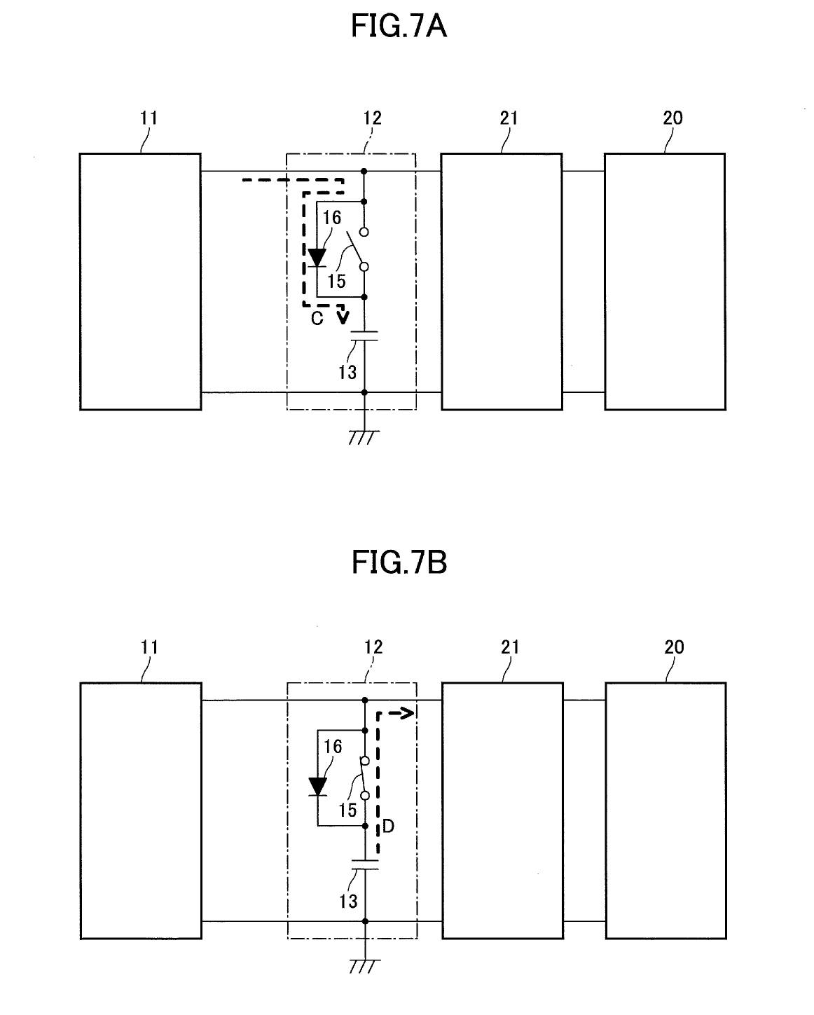

As illustrated in FIG. 7A, when the switch 15 is turned off, an electric current flows from the power source 11 to the capacitor 13 via the diode 16 as illustrated by the dashed arrow C, and the capacitor 13 is charged. When the switch 15 is turned on as illustrated in FIG. 7B, the electric charge stored in the capacitor 13 is supplied to the head controller 21 via the switch 15 as illustrated by the dashed arrow D together with an electric current supplied from the power source 11.

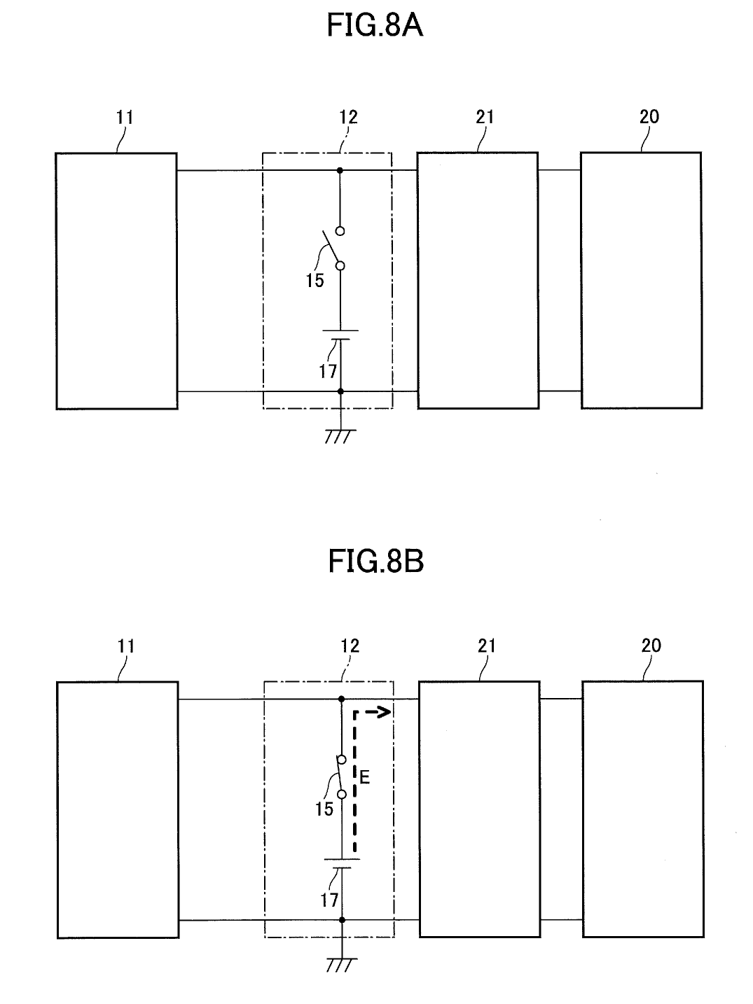

The assisting circuit 12 may use a battery as an auxiliary power source instead of the capacitor 13. In this case, as illustrated in FIG. 8, the battery 17 and the switch 15 are connected in series. The + electrode of the battery 17 is connected to the switch 15, and the − electrode of the battery 17 is connected to the negative terminal of the power source 11. When the battery 17 is used, it is not required to provide a diode.

With respect to the assisting circuit 12 of FIGS. 8A and 8B, an electric current is not supplied from the battery 17 when the switch 15 is turned off as illustrated in FIG. 8A. As illustrated in FIG. 8B, when the switch 15 is turned on, an electric current flows from the battery 17 as illustrated by the dashed arrow E and is supplied to the head controller 21 via the switch 15 together with an electric current supplied from the power source 11.

### Second Embodiment

A second embodiment will be described.

In general, a voltage of from 7 V to 8 V is required to drive a motor and a thermal head in a thermal printer. However, voltages of generally used batteries are around 3.7 V, and it is required to use two batteries of 3.7 V to drive a thermal printer. Further, when a mobile printer receives electric power from a host device such as a personal computer, the supplied voltage need to be boosted in a range of from 7 V to 8 V by a booster for a printing operation, because the voltage of a battery of the host is approximately 3.7 V.

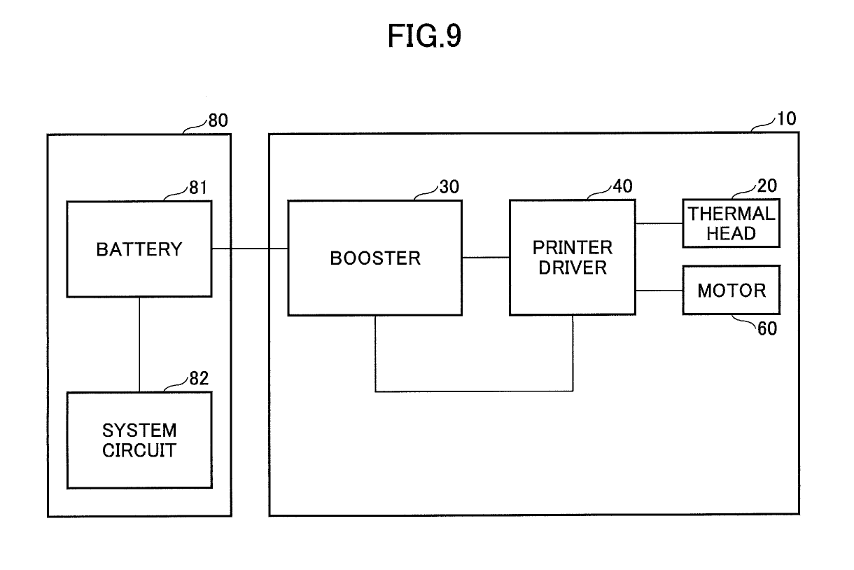

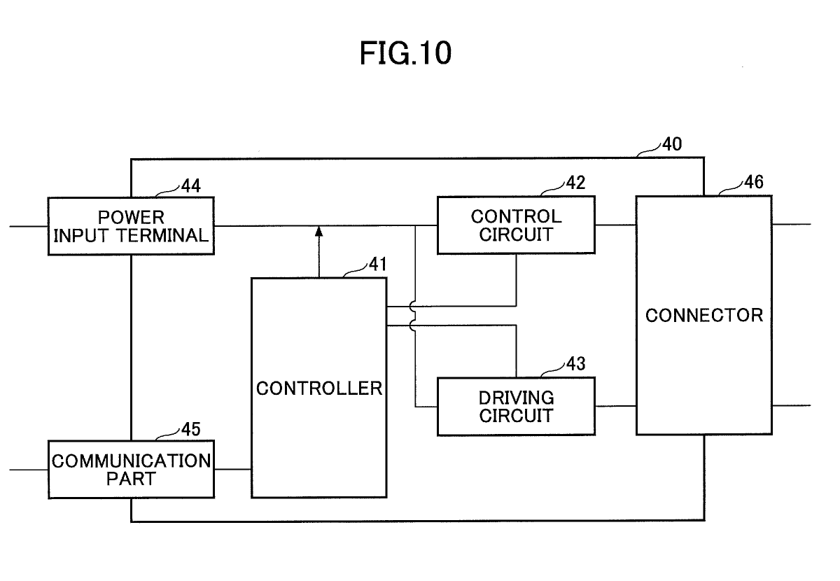

FIG. 9 illustrates a printer 10 that is driven by a battery 81. FIG. 10 illustrates a configuration of a driver 40. As illustrated in FIG. 9, the printer 10 is connected to a host 80, and performs printing by receiving electric power supplied from the battery 81 mounted on the host 80. The printer 10 is provided with a thermal head 20, a booster 30, the driver 40, and a motor 60. The thermal head 20 includes a plurality of print dots formed by resistors, and electric current flows in the print dots to heat the resistors when performing printing on a thermal paper. Further, the driver 40 includes a controller 41, a control circuit 42 for controlling the thermal head, a driving circuit 43 for driving the motor, a power input terminal 44, a communication part 45, and a connector 46.

In addition to the battery 81, a system circuit 82 is provided in the host 80. An element of the host 80 such as the system circuit 82 operates at a voltage of 3.7 V. On the other hand, in the printer 10, a voltage of an electric power from the battery 81 is boosted by the booster 30 to be in a range of from 7 V to 8 V to drive the thermal head 20 and the motor 60.

In the printer 10 illustrated in FIG. 9, upon a large electric current flowing in the thermal head 20, the voltage supplied to the thermal head 20 may drop. Therefore, the voltage boosted by the booster 30 is monitored by the controller 41 to be fed back to the booster 30 in order to maintain a predetermined voltage for performing printing operation.

Assuming that the electric power load on the printer 10 has 8 V and 1 A (8 W) and the conversion efficiency of the booster 30 is 80%, the load on the battery 81 is 8 W/0.8=10 W. Further, if the voltage of the battery 81 is 3.3 V, the electric current is 10 W/3.3 V≈3 A. Thus, even when the consumption current of the printer 10 is 1 A, the consumption current of the battery 81 increases to approximately triple that is approximately 3 A.

When a supply of an electric current is increasing, a voltage drop of the battery 81 also increases due to its internal resistance. Hence, when a large electric current temporarily flows in the thermal head 20, the voltage of the battery 81 may become below 3.3 V, that is an operating voltage of the system circuit 82, and the system of the host 80 may go down. In particular, this phenomenon occurs more noticeably when the voltage of the battery 81 is decreased to be less than that for when the battery 81 is fully charged.

### <Printer>

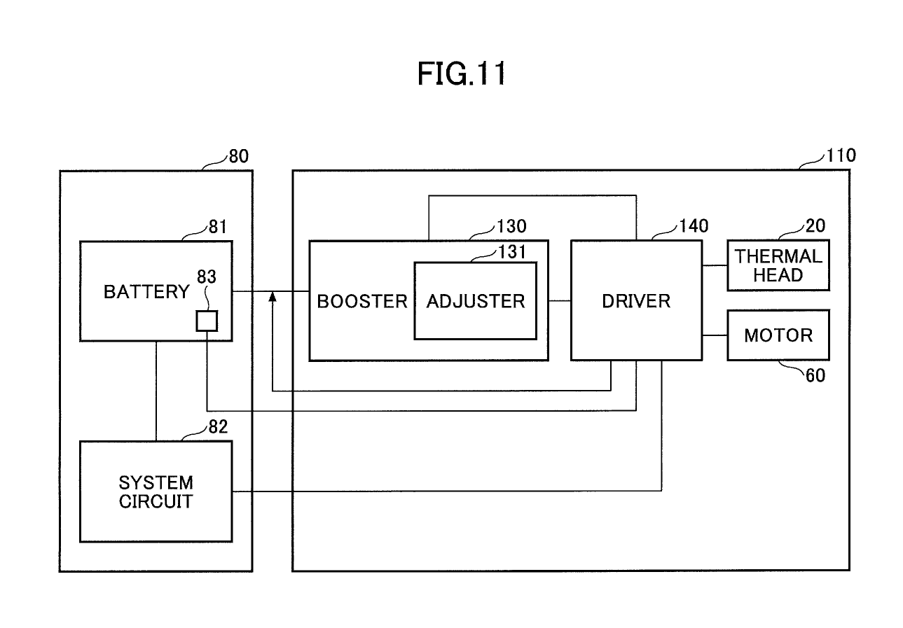

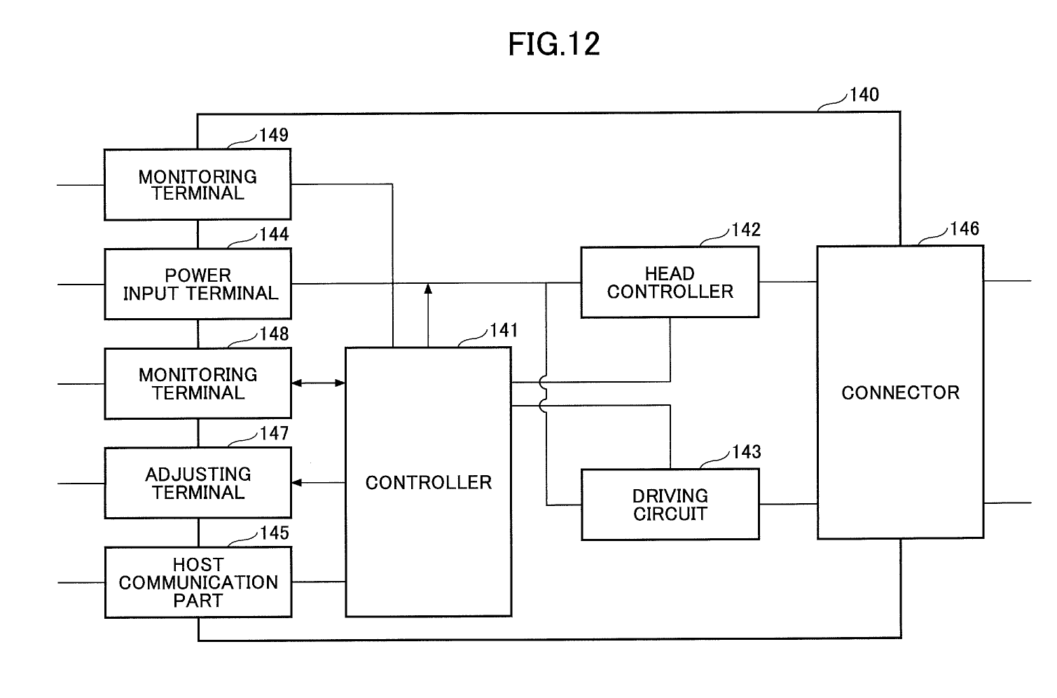

A printer 110 according to the present embodiment will be described. As illustrated in FIG. 11 and FIG. 12, the printer 110 is provided with a thermal head 20, a motor 60, a booster 130, and a driver 140. The driver 140 includes a controller 141, a head controller 142 that controls the thermal head 20, a driving circuit 143 that controls motor driving, a power input terminal 144 for inputting electric power, a communication part 145 that performs communication with the host 80, a connector 146, an adjusting terminal 147, a monitoring terminal 148 for monitoring a battery voltage, and a monitoring terminal 149 for monitoring temperature.

Because the thermal head 20 or the motor 60 operates at a voltage in a range of from 7 V to 8 V, electric power from the battery 81 is boosted by the booster 130 to be in the range of from 7 V to 8 V. The electric power boosted by the booster 130 is input from the booster 130 through the power input terminal 144 to the driver 140 to be used to drive the thermal head 20 and the motor 60 via the head controller 142 and the driving circuit 143. The thermal head 20 and the motor 60 are connected to the connector 146, and the host 80 is connected to the communication part 145.

The booster 130 is provided with an adjuster 131 that adjusts a voltage output from the booster 130. The adjuster 131 is connected to the adjusting terminal 147 to which an output of the booster 130 is input. Further, the battery 81 is provided with a sensor 83 that measures a temperature of the battery 81. The sensor 83 is connected to the monitoring terminal 149.

The controller 141 monitors a voltage boosted by the booster 130, and monitors a voltage of the battery 81. The voltage of the battery 81 is monitored between the battery 81 and the booster 130, and is communicated to the controller 141 via the monitoring terminal 148.

According to the present embodiment, when the monitored voltage of the battery 81 decreases, the output voltage of the booster 130 is decreased to reduce a load electric current on the printer 110. By controlling the output voltage of the booster 130, the electric current supplied from the battery 81 is suppressed, a voltage drop is suppressed, and the voltage of the battery 81 is controlled to be a predetermined voltage. Although an increase degree of the temperature of the thermal head 20 becomes gradual when an electric current flowing in the thermal head 20 decreases, appropriate printing can be performed by making the time period of energizing the print dots longer.

### (Control of Printer)

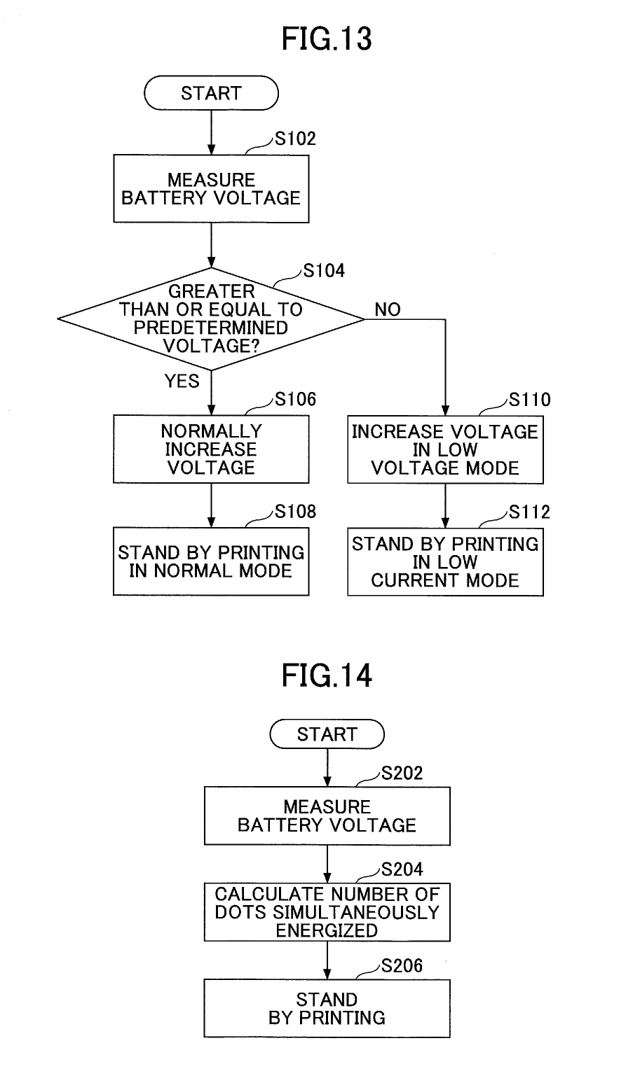

An operation of the controller 141 according to the present embodiment will be described with reference to FIG. 13.

First, in S102, the voltage of the battery 81 is measured. Upon connecting the printer 110 to the battery 81 of the host 80 to turn on the power source, the controller 141 measures the voltage of the battery 81 that is input via the monitoring terminal 148.

In S104, it is determined whether the voltage of the battery 81 is greater than or equal to a predetermined voltage. When the voltage of the battery 81 is greater than or equal to the predetermined voltage (YES in S104), a process according to a normal mode is performed in S106. In contrast, when the voltage of the battery 81 is less than the predetermined voltage (NO in S104), a process of a low current mode in which a load electric current is reduced relative to the normal mode is performed in S110.

The predetermined voltage is a voltage determined that the system circuit 82 may go down due to a voltage drop of the battery 81 when the thermal head 20 or the like is driven. The predetermined voltage may be determined based on a temperature of the battery 81. When the temperature of the battery 81 is low, the internal resistance of the battery 81 is high and a voltage drop is noticeable. Therefore, the predetermined voltage is set to be higher when the temperature of the battery 81 measured by the sensor 83 is low, and the predetermined voltage is set to be lower when the measured temperature of the battery 81 is high. Because the system circuit 82 operates at a voltage greater than or equal to 3.3 V, the predetermined voltage may be set to be 3.5 V, for example.

In S106, the booster 130 boosts the voltage in the normal mode. The controller 141 outputs a signal to the adjuster 131 to instruct the booster 130 to boost the voltage to a normal output voltage, that is 8 V, for example.

In S108, the printer 110 stands by for printing in the normal mode.

In S110, the booster 130 boosts the voltage in a low voltage mode. The controller 141 outputs a signal to the adjuster 131 to instruct the booster 130 to boost the voltage to an output voltage in the low voltage mode that is 4.5 V, for example.

In S112, the printer 110 stands by for printing in the low current mode.

Assuming that the resistance value per dot of the thermal head 20 is 200 Ω and 64 dots are driven. In this case, for the output voltage of 8 V in the normal mode in S108, an electric current that flows in the thermal head 20 is (8 V/200 Ω)×64 dots=2.56 A, and load electric power on the thermal head 20 is 20.48 W. In contrast, for the output voltage of 4.5 V in the low current mode in S112, an electric current that flows in the thermal head 20 is (4.5 V/200 Ω)×64 dots=1.44 A, and load electric power on the thermal head 20 is 6.48 W. As described above, by setting the printer 110 in the low current mode, electric power in the thermal head 20 can be reduced to approximately 30%. Accordingly, a voltage drop of the battery 81 can be suppressed, and the system circuit 82 can be prevented from being inoperative even when printing is performed by the thermal head 20.

A voltage output from the booster 130 may be changed in two levels as described above, or may be changed in three levels, four levels, or the like in a stepwise manner. Also, a voltage output from the booster 130 may be changed consecutively. In this case, a configuration of the adjuster 131 can be changed as appropriate.

### Third Embodiment

A third embodiment will be described. According to the third embodiment, the number of dots energized simultaneously is reduced when the voltage of the battery 81 is low. Because the load electric current of the thermal head 20 changes depending on the number of dots energized, the load electric current of the thermal head 20 is suppressed by reducing the number of dots energized simultaneously when the voltage of the battery 81 is low.

Assuming that the allowable output electric current of the battery 81 is 4 A, the conversion efficiency of the booster 130 is 80%, the voltage output from the booster 130 is 8V, and the resistance value per dot of the thermal head 20 is 200 Ω. In this case, if the voltage of the battery 81 in a fully charged state is 4.2 V, the allowable electric power of the battery 81 is 4.2 V×4 A=16.8 W and the allowable electric power of the thermal head 20 is 16.8 W×0.8=13.4 W. Accordingly, the number N of dots that can be energized simultaneously is 13.4 W/(8 V×8 V/200 Ω)≈41 dots. In contrast, when the voltage of the battery 81 becomes 3.5 V, the allowable electric power of the battery 81 is 3.5 V×4 A=14 W and the allowable electric power of the thermal head 20 is 14 W×0.8=11.2 W. Accordingly, the number N of dots that can be energized simultaneously is 11.2 W/(8 V×8 V/200 Ω)≈35 dots.

### (Control of Printer)

An operation of the controller 141 according to the present embodiment will be described with reference to FIG. 14.

First, in S202, the voltage of the battery 81 is measured. Upon connecting the printer 110 to the battery 81 of the host 80 to turn on the power source, the controller 141 measures the voltage of the battery 81 via the monitoring terminal 148.

In S204, the controller 141 calculates the number of dots to be simultaneously energized based on the measured voltage of the battery 81. The number of dots to be simultaneously energized may be calculated in consideration of the temperature of the battery 81 measured by the sensor 83. When the temperature of the battery 81 is low, the internal resistance of the battery 81 is high and a voltage drop is noticeable. Therefore, the number of dots to be energized may be adjusted such that reducing relatively lager number of dots to be simultaneously energized when the temperature of the battery 81 is low and reducing relatively smaller number of dots to be energized when the temperature of the battery 81 is high. The numbers of dots may be calculated in advance and stored in a memory within the printer 110 such that the stored number of dots is read in accordance with a measured voltage and measured temperature.

In S206, the printer 110 stands by for printing in a state of being able to be driven at the number of dots calculated in S204. The thermal head 20 may be driven at a number of dots less than or equal to the number of dots calculated in S204.

### Fourth Embodiment

A printer according to a fourth embodiment will be described. According to the second embodiment, the time period for energizing the thermal head 20 becomes longer and the printing speed decreases because an output voltage of the booster 130 is decreased. Further, according to the third embodiment, the printing speed decreases because the number of dots energized simultaneously is reduced. According to the fourth embodiment, a decrease of the printing speed is suppressed as far as possible by combining the second embodiment and the third embodiment.

Assuming that the output voltage of the booster 130 is 8 V, the resistance value per dot of the thermal head 20 is 200 Ω, and an electric current of 2 A or less flows in the thermal head 20 to drive the thermal head 20.

In this case, the number of dots that can be simultaneously driven under the above described conditions is 2 A/(8 V/200 Ω)=50 dots. Accordingly, when the number of dots of the thermal head 20 to be driven simultaneously is less than or equal to 50 dots, a dot-divisional mode is not required to drive the thermal head 20 and printing can be performed at a normal printing speed. However, when the number of dots of the thermal head 20 to be driven simultaneously is greater than or equal to 51 dots, a dot-divisional mode is required. When the print dots are divided into two groups, the printing speed is half of that for when the print dots are not divided.

Further, as in the second embodiment, when the output voltage from the booster 130 is decreased, the voltage applied to the thermal head 20 is decreased, and the printing speed also decreases.

Energy P of a resistor for one dot of the thermal head 20 is represented by the following formula 1 where W is electric power applied to the thermal head 20, t is an energization time period of print dots, V is a voltage applied to the thermal head 20 which is equal to an output voltage of the booster 130, and R is a resistance per dot.

$$\begin{matrix}ENERGY P = W \cdot t \\ = \frac{{V}^{2}}{R} \cdot t\end{matrix} \qquad Formula 1$$

In contrast, the voltage at the time of performing printing by dividing the print dots into two groups is 1/\sqrt{2}-fold by the formula 1, as an energization time period t in this mode is as twice as an energization time period in a normal printing mode. In this case, the number of dots that can be energized simultaneously is calculated by the following formula 2, and is 70 dots. As the number of dots to be energized simultaneously decreases to be less than 70 dots, the voltage V can be increased, and the energization time period can be reduced.

Accordingly, if the number of dots to be driven simultaneously is less than or equal to 70, the energization time period of the print dots is less than the twice of that of normal printing mode. Therefore, if the number of print dots is greater than or equal to 51 and less than or equal to 70, the printing speed is faster when driving the print dots at a low voltage relative to the dot-divisional mode. In contrast, if the number of print dots to be energized is greater than or equal to 71, the printing speed is faster when the print dots are driven in dot-divisional mode relative to the case where driving the print dots at a low voltage.

$$2 A / ( \frac{8 V}{\sqrt{2}} / 200 Ω ) = 70 DOTS \qquad Formula 2$$

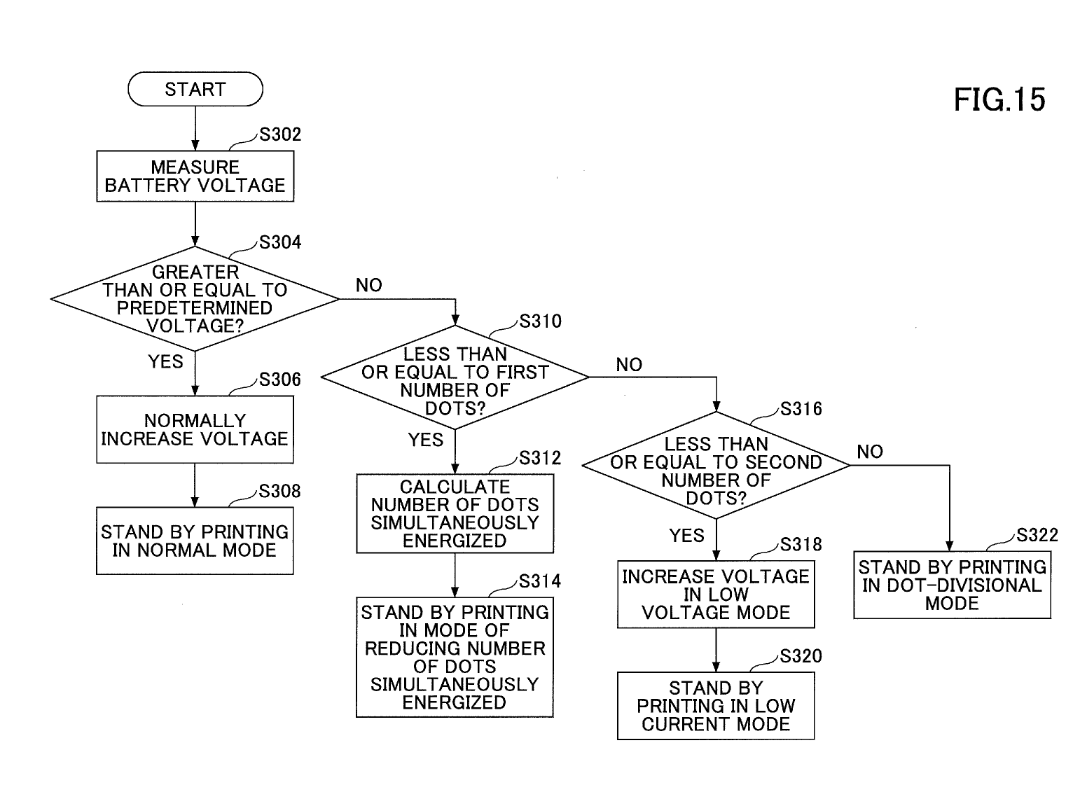

An operation of the controller 141 according to the present embodiment will be described with reference to FIG. 15.

First, in S302, the voltage of the battery 81 is measured by the controller 141 via the monitoring terminal 148.

In S304, whether the voltage of the battery 81 is greater than or equal to a predetermined voltage is determined. When the voltage of the battery 81 is greater than or equal to the predetermined voltage (YES in S304), the process goes to S306. When the voltage of the battery 81 is less than the predetermined voltage (NO in S304), the process goes to S310. The predetermined voltage may be set to be 3.5 V, for example.

In S306, the booster 130 boosts the voltage in the normal mode. The controller 141 outputs a signal to the adjuster 131 to instruct the booster 130 to boost the voltage to a normal output voltage that is 8 V for example.

In S308, the printer 110 stands by for printing in the normal mode.

In contrast, in S310, whether the number of print dots to be simultaneously energized in the thermal had 20 is less than or equal to a first number of dots (50 dots, for example) is determined. When the number of print dots to be energized is less than or equal to the first number of dots (YES in S310), the process goes to S312. When the number of print dots to be energized exceeds the first number of dots (NO in S310), the process goes to S316.

In S312, the controller 141 calculates the number of dots to be simultaneously energized based on the measured voltage of the battery 81. The number of dots to be simultaneously energized is reduced relative to that in the normal mode because the voltage of the battery 81 is lower than the predetermined voltage.

In S314, the printer 110 stands by for printing in a state of that can be driven at the number of dots calculated in S312.

In S316, it is determined whether the number of print dots is less than or equal to a second number of dots (70 dots, for example). When the number of print dots is less than or equal to the second number of dots (YES in S316), the process goes to S318. When the number of print dots exceeds the second number of dots (NO in S316), the process goes to S322.

In S318, the booster 130 boosts the output voltage in a low voltage mode. The controller 141 outputs a signal to the adjuster 131 to instruct the booster 130 to boosts the voltage to an output voltage in the low voltage mode that is 4.5 V.

In S320, the printer 110 stands by for printing in the low current mode.

In S322, the printer 110 stands by for printing in a dot-divisional mode.

With respect to configurations and operations other than the above, the fourth embodiment is similar to the second embodiment or the third embodiment.

Although the embodiments of the present invention have been described above, the above description does not limit the scope of the invention.

The present application is based upon and claims the benefit of priority of the prior Japanese Patent Application No. 2017-040742 filed on Mar. 3, 2017, the entire contents of which are incorporated herein by reference.

What is claimed is:

1. A printer comprising:
a printing head including a plurality of resistors;
a controller configured to drive the printing head by dividing the printing head into at least two areas; and
an assisting circuit that assists power supply,
wherein the controller controls to overlap time periods for driving two different areas, and
wherein, the assisting circuit supplies an electric current to the printing head together with an electric current supplied from the power source during the overlapping period.

2. The printer according to claim 1,
wherein the assisting circuit includes an auxiliary power source and a switch, and
wherein the controller controls the switch to supply the electric current from the auxiliary power source during the overlapping period.

3. A printer comprising:
a printing head including a plurality of resistors;
driver configured to drive the printing head; and
a booster configured to boost a voltage of a power source to be supplied to the driver,
wherein the driver controls to change the voltage output from the booster based on a measured voltage of the power source.

4. The printer according to claim 3, wherein, when the voltage of the power source is less than a predetermined voltage, the driver controls the booster to boost the voltage to a voltage that is less than a voltage in a case where the voltage of the power source is greater than or equal to the predetermined voltage.

5. A printer comprising:
a printing head including a plurality of resistors;
a driver configured to drive the printing head; and
a controller configured to measure the voltage of the power source, to calculate a number of dots to be simultaneously energized based on the measured voltage, and to control the driver to drive the printing head at a number of dots less than or equal to the calculated number of dots.

6. The printer according to claim 5, wherein the driver determines the number of dots that can be simultaneously energized based on the voltage of the power source and a temperature of the power source, and drives the printing head based on the determined number of dots.

7. The printer according to claim 6, wherein the driver determines the voltage to be boosted by the booster and the number of dots that can be simultaneously energized based on the voltage of the power source and the temperature of the power source.
